(19) United States
(12) Patent Application Publication
(10) Pub. No.: US 2009/0281957 A1
(43) Pub. Date: Nov. 12, 2009

(54) Sovereign Debt Fund

(76) Inventor: Tony Unwin, Orlando, FL (US)

Correspondence Address: FURR LAW FIRM, 2622 DEBOLT ROAD, UTICA, OH, 43080, US

(21) Appl. No.: 12/118,651

(22) Filed: May 9, 2008

(51) Int. Cl. G06Q 40/00

(52) U.S. Cl. 705/36 R; 705/38

(57) ABSTRACT

The current invention is a system, method and program product that solves the problems involved with investing in third World debt could be resolved by pledging these assets as contingent capital in a method similar to GFTIU. The proposition could be further enhanced by the establishment of a Sovereign Debt Fund (SDF). The proposition is further enhanced by the establishment of a Sovereign Debt Fund (SDF), which could employ several further methods that would further benefit both the holders of the debt and Governments involved.

### CROSS-REFERENCES TO RELATED APPLICATIONS (IF ANY)

None

### STATEMENT AS TO RIGHTS TO INVENTIONS MADE UNDER FEDERALLY-SPONSORED RESEARCH AND DEVELOPMENT (IF ANY)

None

### BACKGROUND OF INVENTION

1. Field of the Invention

The present invention is directed to a method of handling third world, more particular raising funds through Sovereign Debt Fund.

2. Background

Third world debt is a problem that is facing that needs new option.

These problems are numerous. Holders of 3rd World debt face the challenge of holding an asset that trades at a vast discount to Net Asset Value(NAV). They may be under pressure from auditors to recognize these assets at market value, thus crystalizing their loss. These assets often produce little or no income. The eventual repayment of these assets is often questionable.

Prior Art

United States Patent Application 2002/0184142 filed May 1, 2002 by Suk Michael Whang is for Hybrid securities having protection against event risk using uncorrelated where Hybrid securities defined as last-to-default credit default swaps over multiple name baskets and having protection against event risk. In the preferred embodiment, the hybrid security is defined as a second-to-default credit default swap over a two-name basket, wherein the underlying reference obligors in the basket are uncorrelated or substantially uncorrelated. A portfolio of second-to-default swaps over two-name baskets is provided, wherein the portfolio is defined in a manner that further reduces default risk through enhanced diversification achieved by recombining underlying reference obligors in different second-to-default baskets. A structured investment in a portfolio of underlying second-to-default swaps over two-name baskets is provided using a collateralized debt obligation (CDO) structure. This application makes no reference to third World debt, or other provisions discussed herein. It is simply an alternative payment option for a contingent capital contract.

### SUMMARY OF THE INVENTION

Problems involved with investing in third World debt could be resolved by pledging these assets as contingent capital in a method similar to GFTIU. The proposition could be further enhanced by the establishment of a Sovereign Debt Fund (SDF).

By following the methodology outlined herein the following advantages are possible:
Assets are accepted at full face value. This enables the investor to crystalize the asset at full face value on their balance sheet and means it does not have to recognize a loss.
It is possible for the investor to generate an additional return on the asset in addition to any it may currently receive.
The investor has the option and ability to sell the asset at full face value.
By placing the asset with SDF promptly the investor has the ability to accelerate the redemption of the asset.
The process leaves the country with significantly fewer debtors to negotiate with.
As SDF's asset acquisition cost is nil, it has far greater ability to negotiate with the country than current debt holders.
SDF can offer a similar debt elimination program to the country.

### BRIEF DESCRIPTION OF THE DRAWINGS

Without restricting the full scope of this invention, the preferred form of this invention is illustrated in the following drawings:

FIG. 1 is a schematic block diagram of a conceptualized operation of the present invention; and

FIG. 2 is a block diagram showing a basic arrangement of a computer system that can run the current invention.

### BRIEF DESCRIPTION OF THE PREFERRED EMBODIMENTS

There are a number of significant design features and improvements incorporated within the invention.

The current invention is a system 1, method and program product that solves the problems involved with investing in third World debt could be resolved by pledging these assets as contingent capital in a method similar to GFTIU. The proposition could be further enhanced by the establishment of a Sovereign Debt Fund (SDF).

The proposition is further enhanced by the establishment of a Sovereign Debt Fund (SDF), which could employ several further methods that would further benefit both the holders of the debt and Governments involved.

In the Current Invention:
1. The Holders of third World debt place their asset into a SDF.
2. The SDF accepts the asset at full face value(under some accounting rules, especially those relating to the insurance industry and offshore, the asset can be recognized at full face value, rather than marked to market, as long as it is performing). This further enables the investor to crystalize the asset at full face value on their balance sheet and means it does not have to recognize a loss.
3. SDF uses the asset to provide contingent capital to generate a return. Currently a 7% return is possible with “no risk” and a 10% return with “low risk”. SDF could pay the investor around 2% of assets value a year for the use of the asset. This is a low return, but is 2% better than their current situation and means they do not have to recognize a loss. SDF may charge fees, including a percentage of investment return for its services. SDF recognizing the asset at full face value and paying a return helps stabilize the market for that asset.
4. SDF could use around 5% of asset value received to re-purchase it from the investors. This leads to a further benefit, the potential for re-purchase at full face value. Assets can be redeemed on a First In First Out (FIFO) basis. This is an incentive for investors to join SDF as quickly as possible. As the percentage of the asset held by SDF grows and that held by investors diminishes, the ability to repurchase the assets will compound. It is anticipated that the longest redemption term would be 15 years for an investor, with the first investors being taken out considerably faster, depending on the amount of assets behind them.
5. Within 15 years the entire debt of a third world country can be redeemed and would be held by the fund. At this time SDF can negotiate directly with the country for redemption of the debt (now being held entirely by SDF) as 1 debtor, rather than many. The country could be offered a similar process to retire the debt entirely, leaving it debt free. This has significant benefits over traditional IMF financing methods which are unpopular, as the tend to load countries with additional debt and onerous restrictions.

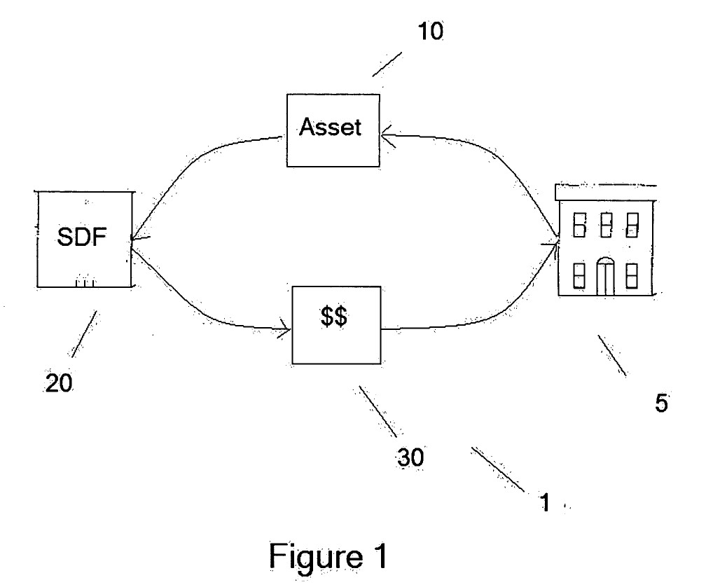

This system is shown in FIG. 1, the holders 5 of the third world debt 10, place their debts into a SDF 20. The SDF 20 will pay out a return 30 to the holders 5.

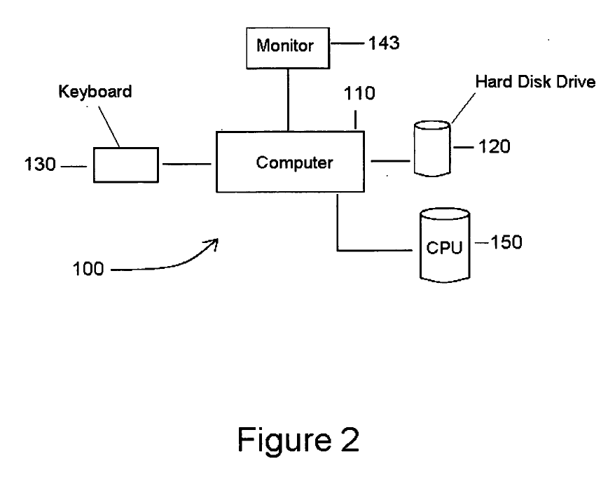

The system 1 can be set up to be run a on a computing device. FIG. 2 is a block diagram showing a computing device 100 on which the present invention can run comprising a CPU 110, Hard Disk Drive 120, Keyboard 130, Monitor 140, CPU Main Memory 150 and a portion of main memory where the program resides and executes. A printer can also be included. Any general purpose computer with an appropriate amount of storage space is suitable for this purpose. Computer Devices like this are well known in the art and is not pertinent to the invention.

The computer device 100 could be connected to other computer devices 100 through a communication interface such as the Internet, a wide area network (WAN), internetwork, telephone network or a private Value Added Network (VAN).

The storage and databases for the system may be implemented by a single data base structure at an appropriate site, or by a distributed data base structure that is distributed across an intra or an Internet network.

The files and file components discussed herein may be paper files, but in a preferred embodiment comprise data structures with electronic data. The setting up of the files and file structure is commonly known in the art and is not disclosed here.

It should be appreciated that many other similar configurations are within the abilities of one skilled in the art and all of these configurations could be used with the method of the present invention. Furthermore, it should be recognized that the computer system and network disclosed herein can be programmed and configured by one skilled in the art in a variety of different manners to implement the method steps described further herein.

Advantages

The Advantages of the Current Invention is That:
Investors do not have to recognize losses.
Investors can generate an additional return on the asset.
The investor has the option and ability to sell the asset at full face value.
By placing the asset with SDF promptly the investor has the ability to accelerate the redemption of the asset.
The process leaves the country with significantly fewer debtors to negotiate with.
As SDF's asset acquisition cost is nil, it has far greater ability to negotiate with the country than current debt holders.
SDF can offer a similar debt elimination program to the country.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A method comprising the steps: having holders of third world debt place said assets into a Sovereign Debt Fund.

2. The method as defined in claim 1, wherein said SDF accepts the asset at full face value.

3. The method as defined in claim 1, where said SDF uses the asset to provide contingent capital to generate a return.

4. The method as defined in claim 1, where said SDF charge fees for its services.

5. The method as defined in claim 3, where said return will be no risk.

6. The method as defined in claim 3, where said return will be low risk.

7. The method as defined in claim 1, where said SDF could re-purchase assets for the investors.

8. The method as defined in claim 7, where said assets are repurchased on a First In First Out basis.

9. The method as defined in claim 1, where said SDF will negotiate with the country for repayment of the debt.

10. The method as defined in claim 1, where said method is processed on a computing device.

11. A system comprising: having holders of third world debt place said assets into a Sovereign Debt Fund.

12. The system as defined in claim 11, wherein said SDF accepts the asset at full face value.

13. The system as defined in claim 11, where said SDF uses the asset to provide contingent capital to generate a return.

14. The system as defined in claim 11, where said SDF charge fees for its services.

15. The system as defined in claim 13, where said return will be no risk.

16. The system as defined in claim 13, where said return will be low risk.

17. The system as defined in claim 11, where said SDF could re-purchase assets fro the investors.

18. The system as defined in claim 17, where said assets are repurchased on a First In First Out basis.

19. The system as defined in claim 11, where said SDF will negotiate with the country for repayment of the debt.

20. The system as defined in claim 1 processed on a computing device.
